(19) United States
(12) Patent Application Publication
(10) Pub. No.: US 2022/0309352 A1
(43) Pub. Date: Sep. 29, 2022

(54) METHOD FOR TRAINING ARTIFICIAL NEURAL NETWORK AND ELECTRONIC DEVICE FOR SUPPORTING THE SAME

(71) Applicant: Samsung Electronics Co., Ltd., Suwon-si, Gyeonggi-do (KR)

(72) Inventors: Dongyul LEE, Suwon-si (KR); Jaeyung YEO, Suwon-si (KR)

(21) Appl. No.: 17/429,185

(22) PCT Filed: Jul. 22, 2021
(86) PCT No.: PCT/KR2021/009491

§ 371 Date: Aug. 6, 2021

(30) Foreign Application Priority Data
Oct. 15, 2020 (KR) 10-2020-0133261

(51) Int. Cl. G06N 3/08; G06N 3/04; G06N 3/063

(52) U.S. Cl. CPC G06N 3/084; G06N 3/0454; G06N 3/063

(57) ABSTRACT

Provided is an electronic device including a first processor, a second processor, and a memory that stores at least one artificial neural network (ANN) including an input layer and an output layer and operatively connected with the first processor and the second processor. The first processor receives a request to train the ANN, performs a forward propagation operation by inputting input data into the input layer of a first ANN of the at least one ANN, and stores, in the memory, first result data generated based on the forward propagation operation. The second processor performs a backward propagation operation by inputting the first result data into the output layer of a second ANN of the at least one ANN, and updates weights included in the second ANN based on the backward propagation operation. Besides, various embodiments as understood from the specification are also possible.

### TECHNICAL FIELD

The disclosure relates to a method for training an artificial neural network (ANN) and an apparatus for supporting the same.

### BACKGROUND ART

An artificial intelligence (AI) system is a computer system that implements human-level intelligence. In the computer system, machine learns and judges alone. In addition, as the machine is more used, the cognition rate is more improved.

An AI technology includes a machine learning (e.g., deep learning) technology based on an algorithm of self-classifying and/or self-learning features of input data and element technologies of emulating cognition and judge functions of a human brain by utilizing a machine learning algorithm. The AI technology is to provide services, such as object recognition and voice recognition, by using a neural network included in the AI system.

The element technology may include, for example, a language understanding technology to recognize languages or characters of human beings. The language understanding technology, which is to recognize, apply, and process languages or characters of human beings, may include a natural language processing technology, a machine translation technology, a conversational system technology, a query answering technology, a voice recognition technology and/or a synthesis technology.

### DISCLOSURE

### Technical Problem

According to the related art, an electronic device may require a high computing capability and a considerable amount of data to train an ANN. Accordingly, there is a limitation in training the ANN by using a portable electronic device (e.g., a smartphone). Accordingly, it may be difficult to train the ANN through a scheme in which the portable electronic device transmits data, which is necessary for training the ANN, to a higher-performance electronic device, and the higher-performance electronic device synchronizes the ANN, which is trained based on the data, with an ANN inside the portable electronic device.

In addition, when the portable electronic device trains the ANN, additional and repeated training (e.g., fine-tuning) may be required in association with a specified function (e.g., a fingerprint recognition function and/or a face recognition function) using user personal information (e.g., information on the fingerprint of a user and/or information on a face of the user). To train the above-described ANN, personal information requiring security may be needed to be transmitted to the outside (e.g., the higher-performance electronic device).

### Technical Solution

In accordance with an aspect of the disclosure, an electronic device may include a first processor, a second processor, and a memory which stores at least one artificial neural network (ANN) including an input layer and an output layer and is operatively connected with the first processor and the second processor. For example, the first processor may be configured to receive a request to train the ANN, perform a forward propagation operation by inputting input data into the input layer of a first ANN of the at least one ANN, and store, in the memory, first result data generated based on the forward propagation operation, and the second processor may be configured to perform a backward propagation operation by inputting the first result data into the output layer of a second ANN of the at least one ANN, and update weights included in the second ANN based on the backward propagation operation.

In accordance with another aspect of the disclosure, a method for performing an operation of training an artificial neural network (ANN) by an electronic device may include receiving a request to train the ANN, performing, through a first processor, a forward propagation operation by inputting input data into the input layer of a first ANN, and storing, in a memory, first result data generated based on the forward propagation operation, and performing, through a second processor, a backward propagation operation by inputting the first result data into the output layer of a second ANN, and updating weights included in the second ANN based on the backward propagation operation.

### Advantageous Effects

According to various embodiments of the disclosure, the electronic device may provide the effective learning function by performing a computation using the optimized hardware components and/or software components in each stage necessary to train the ANN.

According to various embodiments of the disclosure, the electronic device may perform the fine-tuning operation by autonomously using personal information (e.g., the information on the fingerprint and/or face of the user), which requires higher security, of data necessary to train the ANN, without transmitting the personal information to the outside (e.g., the higher-performance electronic device).

Besides, a variety of effects directly or indirectly understood through the disclosure may be provided.

### BRIEF DESCRIPTION OF THE DRAWINGS

FIG. 1 is a block diagram of an electronic device under a network environment, according to various embodiments;

FIG. 2 is a block diagram illustrating components included in an electronic device, according to various embodiments;

FIG. 3 is a schematic view illustrating that an electronic device performs an operation of training an artificial neural network, according to various embodiments;

FIG. 4 is a block diagram illustrating components of an electronic device including a learning distributor, according to various embodiments;

FIG. 5 is a block diagram illustrating components of an electronic device including a learning distributor, according to various embodiments;

FIG. 6 is a block diagram illustrating components of an electronic device including a learning distributor, according to various embodiments;

FIG. 7 illustrates a flowchart for the operation of an electronic device, according to various embodiments;

FIG. 8 illustrates a flowchart for the operation of an electronic device, according to various embodiments;

FIG. 9 illustrates a flowchart for the operation of an electronic device, according to various embodiments; and

FIG. 10 illustrates a flowchart for the operation of an electronic device, according to various embodiments.

With respect to the description of the drawings, the same or similar reference signs may be used for the same or similar elements.

### MODE FOR CARRYING OUT THE DISCLOSURE

Hereinafter, various example embodiments of the disclosure will be described in greater detail with reference to the accompanying drawings. However, it should be understood that the disclosure is not limited to specific embodiments, but rather includes various modifications, equivalents and/or alternatives of the embodiments of the present disclosure.

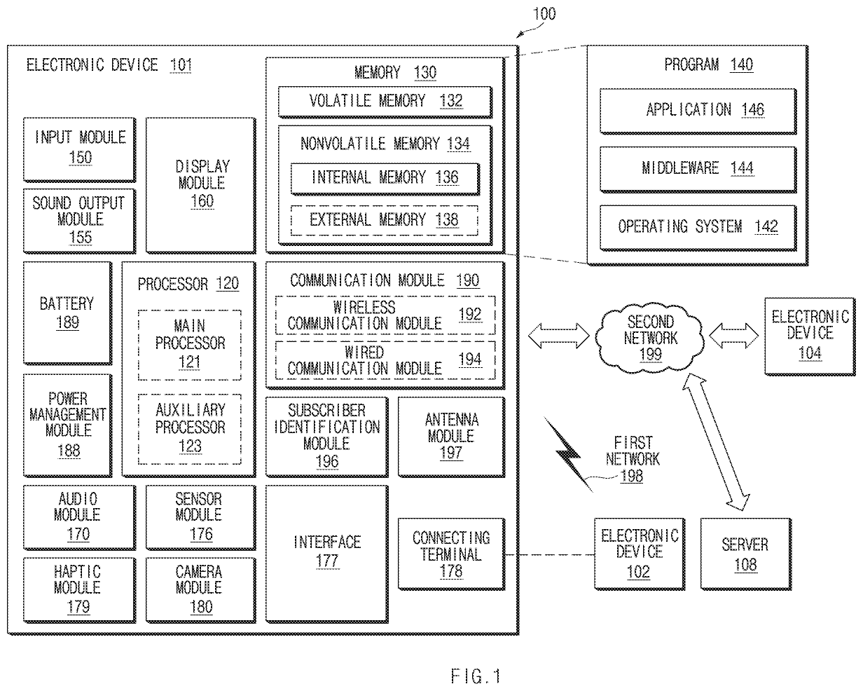

FIG. 1 is a block diagram illustrating an electronic device 101 in a network environment 100 according to various embodiments. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

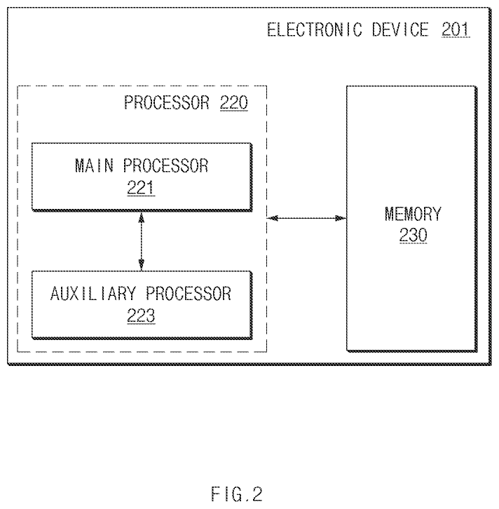

FIG. 2 is a block diagram 200 illustrating components included in an electronic device 201, according to various embodiments.

According to various embodiments of the disclosure, the electronic device 201 (e.g., the electronic device 101 of FIG. 1) may include a processor 220 (e.g., the processor 120 of FIG. 1) and a memory 230 (e.g., the memory 130 of FIG. 1). The processor 220 may include a main processor 221 (e.g., the main processor 121 of FIG. 1) and an auxiliary processor 223 (e.g., the auxiliary processor 123 of FIG. 1). The components illustrated in FIG. 2 are provided for the illustrative purpose, and the embodiments of the disclosure are not limited thereto. For example, the auxiliary processor 223 may be implemented as a portion of the main processor 221. The electronic device 201 may further include components, which are not illustrated, or may exclude a portion of the components illustrated.

The processor 220 may be operatively connected with the memory 230. The memory 230 may store at least one instruction that causes the processor 220 to perform various operations of the electronic device 201 when executed.

According to an embodiment, the processor 220 may include the main processor 221 and the auxiliary processor 223. For example, the main processor 221 may be a central processing unit (CPU) or a graphic processing unit (GPU). The auxiliary processor 223 may be a neural processing unit (NPU). The main processor 221 may be operatively connected with the auxiliary processor 223. The processor 220 may allocate mutually different data (e.g., learning data) to the main processor 221 and the auxiliary processor 223.

According to an embodiment, the main processor 221 may perform at least a portion of an operation (ANN training operation) of training an artificial neural network (ANN). For example, the main processor 221 may perform a backward propagation operation by inputting learning data into an ANN which is de-quantized. The main processor 221 may update weights of a plurality of layers included in the ANN through the backward propagation operation. The main processor 221 may store, in the memory 230, data (e.g., a weight which is not updated and/or a weight which is updated) generated during the backward propagation operation.

According to an embodiment, the auxiliary processor 223 may perform at least a portion of an operation (ANN training operation) of training the ANN. For example, the auxiliary processor 223 may be configured to be specified for a specific function (e.g., a forward propagation operation for the ANN). For example, the auxiliary processor 223 may perform the forward propagation operation by inputting learning data into an ANN which is quantized. The auxiliary processor 223 may output result data, which is generated based on the learning data input into the ANN, through the forward propagation operation. The auxiliary processor 223 may store, in the memory 230, data (e.g., the learning data input into the ANN and/or the result data) generated during the forward propagation operation.

In FIG. 2, data processed through the ANN may be data corresponding to an image, a video, a voice, or the combination thereof, but the disclosure is not limited thereto. In addition, although FIG. 2 illustrates that the processor 220 includes the main processor 221 and the auxiliary processor 223, the processor 220 may further include at least one auxiliary processor.

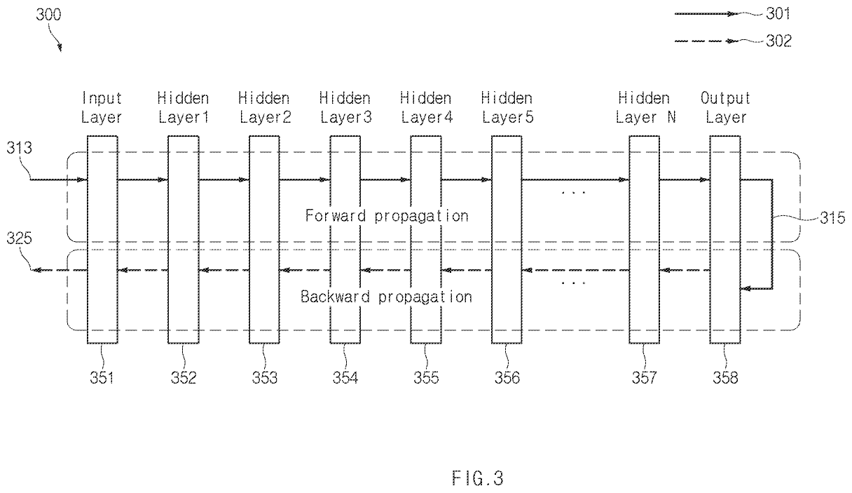

FIG. 3 is a schematic view 300 illustrating that an electronic device trains an ANN, according to various embodiments.

According to an embodiment, an electronic device (e.g., the electronic device 101 of FIG. 1) may perform a neural network processing operation by inputting learning data into an ANN. For example, the electronic device may perform the neural network processing operation by inputting mutually different learning data into ANNs (e.g., a first ANN or a second ANN) which are generated, as one ANN is quantized or de-quantized.

According to an embodiment, the electronic device may input first learning data 313, which is stored in a memory (e.g., the memory 130 of FIG. 1), into the first ANN. For example, the first ANN may be referred to as an ANN generated as the electronic device quantizes an ANN previously stored. The electronic device 201 may use an auxiliary processor (e.g., the auxiliary processor 223 of FIG. 2) to perform the neural network processing operation (e.g., a forward propagation operation 301) through the first ANN. For example, the electronic device may allow the auxiliary processor (e.g., a neural processing unit (NPU)) to perform the forward propagation operation 301 by inputting the first learning data 313 into the first ANN. The auxiliary processor may input the first learning data 313 into an input layer 351 of the first ANN, may allow the first learning data 313 to sequentially pass through a plurality of layers 352 to 357 in order of the layers 352 to 357, and may output first result data 315 generated through an output layer 358. For example, the first result data 315 may be referred to as input data into an ANN (e.g., the second ANN) different from the first ANN. The auxiliary processor may store, in the memory, at least a portion of data generated from the plurality of layers 352 to 357 in the process of performing the forward propagation operation 301 through the first ANN.

According to an embodiment, the electronic device 201 may input the first result data 315, which is generated through the output layer 358 of the first ANN, into the second ANN. For example, the second ANN may be referred to as an ANN generated as the electronic device de-quantizes an ANN previously stored. The electronic device 201 may use the main processor (e.g., the main processor 221 of FIG. 2) to perform the neural network processing operation (e.g., the backward propagation operation 302) through the second ANN. For example, the electronic device may allow the main processor (e.g., a central processing unit (CPU) or a graphic processing unit (GPU)) to perform the backward propagation operation 302 by inputting the first result data 315 into the second ANN. The main processor may input the first result data 315 into the output layer 358 of the second ANN, may allow the first result data 315 to sequentially pass through the plurality of layers 352 to 357 in order of the layers 357 to 352, and may output second result data 325 generated through the input layer 351. The main processor may store, in the memory, at least a portion of data generated from the plurality of layers 352 to 357 in the process of performing the backward propagation operation 302 through the second ANN.

According to an embodiment, an operation that the electronic device obtains result data through an ANN may be repeated until a specified condition is satisfied. For example, the electronic device may identify the preset number of times or an amount of learning data input into the ANN, and may repeat the neural network processing operation by using a plurality of processors, when it is determined that the identification result fails to satisfy the specified condition.

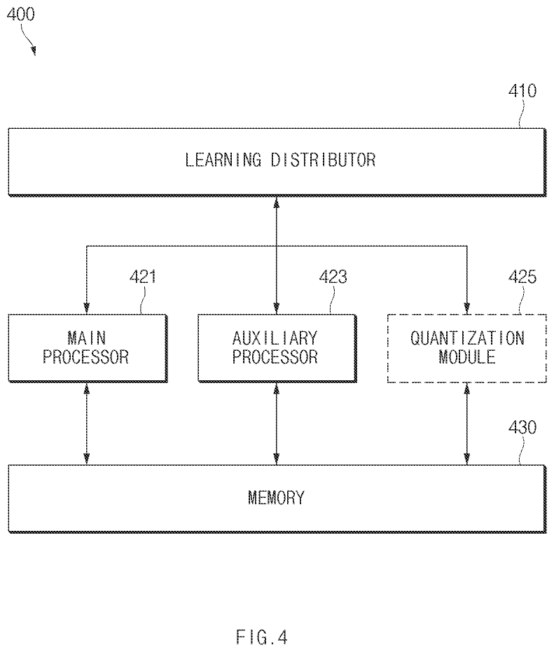

FIG. 4 is a block diagram 400 illustrating components of an electronic device including a learning distributor 410, according to various embodiments.

Referring to FIG. 4, according to an embodiment, an electronic device (e.g., the electronic device 101 of FIG. 1) may control a plurality of processors 421 to 423 through the learning distributor 410. For example, the learning distributor 410 may perform a control operation to determine a processor to perform the neural network processing operation.

According to an embodiment, the learning distributor 410 may control a main processor 421 (e.g., the main processor 221 of FIG. 2) to perform a neural network processing operation (e.g., the backward propagation operation) through the second ANN (e.g., an ANN de-quantized). For example, the main processor 421 may load the second ANN stored in a memory 430 (e.g., the memory 130 of FIG. 1), and may input learning data, and may perform the backward propagation operation.

According to an embodiment, the learning distributor 410 may control an auxiliary processor 423 (e.g., the auxiliary processor 223 of FIG. 2) to perform a neural network processing operation (e.g., the forward propagation operation) through a first ANN (e.g., an ANN quantized) For example, the auxiliary processor 423 may load the first ANN stored in the memory 430 (e.g., the memory 130 of FIG. 1 and may input learning data, and may perform the forward propagation operation.

According to an embodiment, the electronic device may further include a quantization module 425 operatively connected with the learning distributor 410 and the memory 430. For example, the quantization module 425 may generate a new ANN by quantizing an ANN stored in the memory 430. For another example, the quantization module 425 may generate a new ANN (e.g., a third ANN) by de-quantizing the ANN quantized. The quantization module 425 may store the third ANN into the memory 430.

According to an embodiment, the processors 421 and 423 may store, in the memory 430, at least one piece of data obtained through the ANN. The processors 421 and 423 may repeatedly perform the neural network processing operation by using the stored at least one piece of data.

According to various embodiments of the disclosure, the processors may perform neural network processing operations through mutually different ANNs. For example, the main processor 421 may be a component corresponding to the CPU and/or the GPU. The electronic device may use a CPU and/or a GPU optimized to decimal computation such that the neural network processing operation is performed through the second ANN. For example, the second ANN may be defined as an ANN including at least one layer including a weight having a decimal value. For another example, the auxiliary processor 423 may be a component corresponding to the NPU. The electronic device may use an NPU optimized to integer computation such that the neural network processing operation is performed through the first ANN. For example, the first ANN may be defined as an ANN including at least one layer including a weight having an integer value. The electronic device may distribute a control signal for performing mutually different neural network processing operations, to at least one processor through the learning distributor 410.

Although FIG. 4 illustrates that the quantization module 425 performs the neural network processing operations, various embodiments of the disclosure is not limited thereto. For example, the electronic device may perform the quantization operation and/or the de-quantization operation by using the main processor 421.

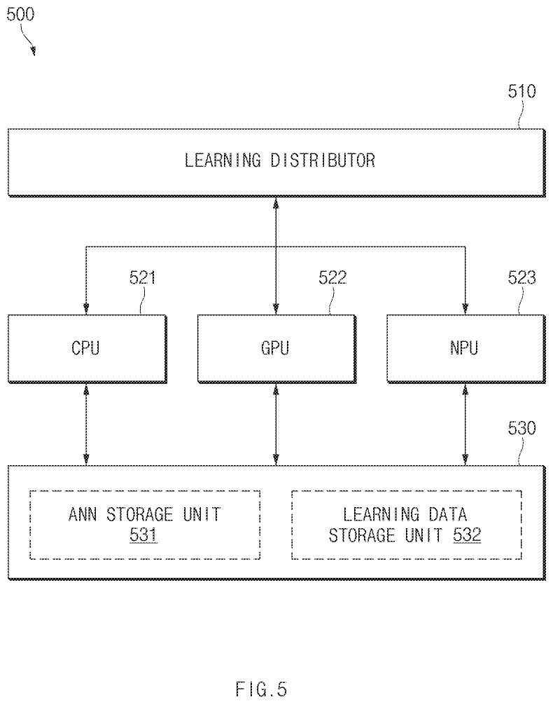

FIG. 5 is a block diagram 500 illustrating components of an electronic device including a learning distributor 510, according to various embodiments.

The description of components (e.g., the learning distributor 510 and a memory 530) defined with the same names as those of components of FIG. 4 may be understood by making reference to the description of the components of FIG. 4.

Referring to FIG. 5, according to an embodiment, the memory 530 (e.g., the memory 130 of FIG. 1) may include an ANN storage unit 531 and a learning data storage unit 532.

According to an embodiment, the ANN storage unit 531 may store at least one ANN (e.g., the first ANN and/or the second ANN). The electronic device (e.g., the electronic device 101 of FIG. 1) may quantize and de-quantize an ANN which is previously stored in the ANN storage unit 531, by using the CPU 521 or the quantization module (e.g., the quantization module 425 of FIG. 4). The electronic device may store ANNs, which are quantized and/or the de-quantized, in the ANN storage unit 531.

According to an embodiment, the learning data storage unit 532 may store at least one piece of learning data. For example, the electronic device may store, in the learning data storage unit 532, learning data (e.g., activation) used to perform a neural network processing operation (e.g., the forward propagation operation) through an NPU 523. For another example, the electronic device may store, in the learning data storage unit 532, learning data used to perform a neural network processing operation (e.g., the forward propagation operation) through a CPU 521 and/or a GPU 522. For another example, the electronic device may store, in the learning data storage unit 532, learning data generated in the process of performing the neural network processing operation through the CPU 521, the GPU 522, and/or the NPU 523.

According to an embodiment, the electronic device may load data stored in the memory 530 to perform the neural network processing operation through at least one processor (e.g., the CPU 521, the GPU 522, and/or the NPU 523). For example, the electronic device may load, to at least one processor, at least one ANN stored in the ANN storage unit 531 to perform the ANN training operation. For example, the electronic device may load, to at least one processor, at least one learning data stored in the learning data storage unit 532 to perform the ANN training operation.

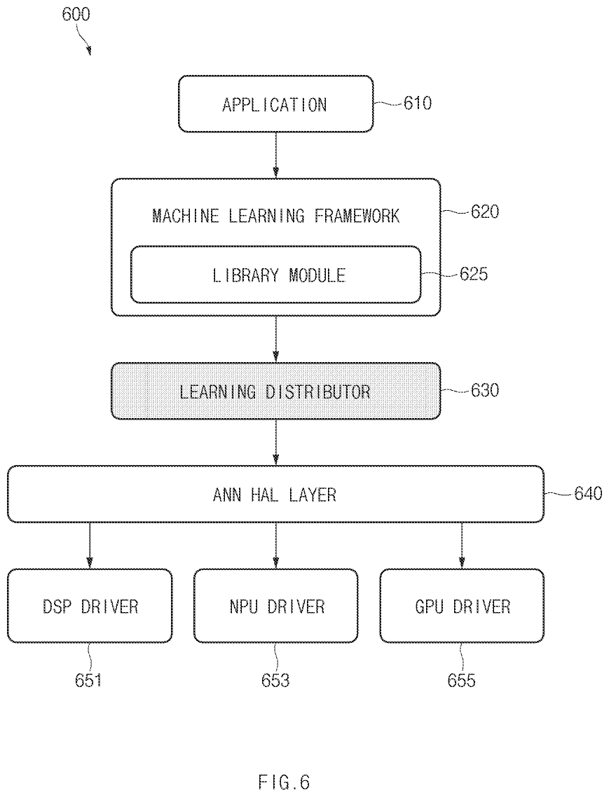

FIG. 6 is a block diagram 600 illustrating components of an electronic device including a learning distributor 630, according to various embodiments.

According to an embodiment, an electronic device (e.g., the electronic device 101 of FIG. 1) may store various data necessary for training an ANN in a memory (e.g., the memory 130 of FIG. 1). For example, the electronic device may store, in the memory, input data or output data for software (e.g., the program 140 of FIG. 1) and a command associated with the software. The electronic device may store program having a structure as illustrated in FIG. 6. The memory may store components having the structure in the block diagram 600 illustrated in FIG. 6. For example, the components may include an application 610, a machine learning framework 620, a library module 625, a learning distributor 630, an ANN HAL (Hardware Abstraction Layer) layer 640, and/or drivers 651, 653, and 655.

According to an embodiment, the application 610 (e.g., the application 146 of FIG. 1) refers to program for providing, to a user, a specific function (e.g., an image capturing function, a gaming function, and/or a search function). For example, the application 610 may be preloaded onto the electronic device in the manufacturing stage of the electronic device. For another example, when the electronic device is used by the user, the application may be downloaded or updated from an external electronic device (e.g., the server 108 of FIG. 1).

According to an embodiment, the machine learning framework 620 may provide various functions to the application 610 such that a function and/or information provided from at least one resource included in the electronic device is used through the application 610. The machine learning framework 620 may include a library module 625.

According to an embodiment, the library module 625 may be included in the machine learning framework 620. The library module 625 may be referred to as a software module used by a compiler to add new functions through a programming language while a program is being executed. The library module 625 may be a software module used when the electronic device trains the ANN. For example, the library module 625 may include various algorithms (e.g., a supervised learning, unsupervised learning, semi-supervised learning, or reinforcement learning algorithm) associated with training the ANN. For example, the library module 625 may provide a function of quantizing an ANN included in the electronic device. The library module 625 may allow a processor (e.g., the processor 120 of FIG. 1) to change a quantized ANN into a de-quantized ANN, or change a de-quantized ANN into a quantized ANN. For example, the quantized ANN may be referred to as an integer-type ANN in which weights included in the plurality of layers have integer values. For another example, the de-quantized ANN may be referred to as a decimal-type ANN in which weights included in a plurality of layers have decimal values. The library module 625 may identify the types of a plurality of ANNs, and may allow mutually different processors (e.g., the main processor 221 or the auxiliary processor 223 of FIG. 2) to train the ANNs, based on the identified types of the ANNs. For example, the library module 625 may provide a software development kit (SDK) and/or an application programming interface (API) to a user. The electronic device may receive an external input for changing the SDK and/or API. For an example, the user may change a plurality of parameters, which are associated with the ANN training operation, to previously set values by changing the provided SDK and/or API. The library module 625 may perform the ANN training operation by using the SDK and/or API changed by the user.

According to an embodiment, the learning distributor 630 may transmit and receive data with the machine learning framework 620 and/or the ANN HAL layer 640. For example, the learning distributor 630 may classify learning data stored in the memory (e.g., the memory 130 of FIG. 1) depending on whether the ANN is quantized. For example, the learning distributor 630 may allocate learning data to at least one of a plurality of processors, which are included in the electronic device, to perform an operation (ANN training operation) of training the ANN. The learning distributor 630 may distribute and transmit data such that the plurality of processors perform the ANN training operation through mutually different ANNs. For example, the learning distributor 630 may allow the NPU to perform the forward propagation operation by inputting the learning data into the first ANN (e.g., the ANN quantized). For another example, the learning distributor 630 may allow the CPU or the GPU to perform the backward propagation operation by inputting the learning data (e.g., the result data output after the forward propagation operation is performed in the first ANN) into the second ANN (e.g., the ANN de-quantized).

According to an embodiment, the ANN HAL layer 640 may perform data transmission or reception between the plurality of layers. The ANN HAL layer 640 may manage an abstracted layer among at least one of hardware components included in the electronic device, the application 610, and the machine learning framework 620. For example, the ANN HAL layer 640 may transmit at least some of data transmitted through the application 610 to a plurality of drivers (e.g., the digital signal processor (DSP) driver 651, the NPU driver 653, and/or the GPU driver 655). For another example, the ANN HAL layer 640 may receive information transmitted by the machine learning framework 620, generate a control signal based on the information, and transmit the control signal to at least one of the plurality of drivers.

According to an embodiment, the DSP driver 651 may provide an interface to control and/or manage a DSP. According to an embodiment, the NPU driver 653 may provide an interface to control and/or manage the NPU. For example, the DSP or NPU may be referred to as an example of the auxiliary processor 123 of FIG. 1. According to an embodiment, the GPU driver 655 may provide an interface to control and/or manage the GPU. For example, the GPU may be referred to as an example of the main processor 121 of FIG. 1. According to various embodiments of the disclosure, a DSP, NPU, and/or GPU may be used for a neural network processing operation through an ANN.

The layer structure of FIG. 6 is provided for illustrative purpose, and various embodiments of the disclosure are not limited thereto. For example, the ANN HAL layer 640 may transmit data to a CPU driver (not illustrated). The CPU driver may provide an interface to control and/or manage a CPU (e.g., the main processor 121 of FIG. 1).

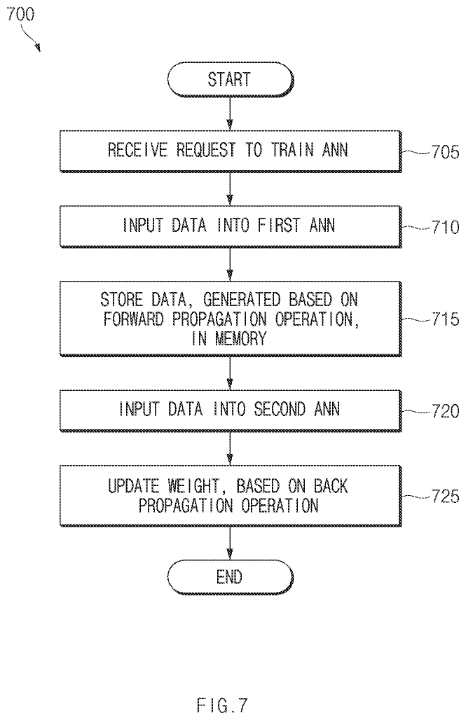

FIG. 7 illustrates a flowchart 700 for the operation of an electronic device, according to various embodiments.

According to an embodiment, an electronic device (e.g., the electronic device 101 of FIG. 1) may perform operations of FIG. 7. For example, a processor (e.g., the processor 120 of FIG. 1) of the electronic device may be configured to perform the operations of FIG. 7, when instructions stored in a memory (e.g., the memory 130 of FIG. 1) are executed.

In operation 705, the electronic device may receive a request to train a neural network. For example, the electronic device may receive a request, which is input by a user, to train a neural network or may receive a request to train a neural network in a preset cycle. The request to train the neural network may include information associated with an ANN, which is to be trained, of at least one ANN stored in the memory. The electronic device may identify or determine the ANN to be trained, based on the information.

In operation 710, the electronic device may input data into the first ANN. For example, the first ANN may correspond to an ANN generated, as the first processor (e.g., the main processor 121 of FIG. 1) or a quantization module (e.g., the quantization module 425 of FIG. 4) quantizes the ANN determined based on the request to train the neural network. The first ANN may include at least one layer. For example, at least one layer in the first ANN may include a weight having an integer value. The electronic device may input at least some of the learning data stored in a learning data storage unit (e.g., the learning data storage unit 532 of FIG. 5), into an input layer of the first ANN. The neural network processing operation based on the first ANN may be performed by the first processor.

In operation 715, the electronic device may store data, which is generated based on the forward propagation operation, in the memory. For example, the forward propagation operation may correspond to an inference operation using an ANN. For example, the electronic device may perform the forward propagation operation in which input data is input into the first ANN through the first processor, and sequentially passes through at least one layer in the first ANN, thereby outputting result data. The first processor may store, in the memory, at least some of data generated from at least one layer in the process of performing the forward propagation operation.

In operation 720, the electronic device may input data into the second ANN. For example, the second ANN may correspond to an ANN which is generated as the second processor or the quantization module de-quantizes the ANN determined based on the request to train the neural network. The second ANN may include at least one layer. For example, at least one layer in the second ANN may include a weight having a decimal value. The electronic device may input at least some of the learning data stored in a learning data storage unit inside the memory, into an output layer of the second ANN. The neural network processing operation based on the second ANN may be performed by the second processor (e.g., the auxiliary processor 123 of FIG. 1).

In operation 725, the electronic device may update a weight included in the ANN, based on the backward propagation operation. For example, the electronic device may perform an operation in which learning data input into the second ANN sequentially passes through at least one layer, thereby updating weights included in the at least one layer. The operation of updating the weights included in the ANN may be performed by the second processor.

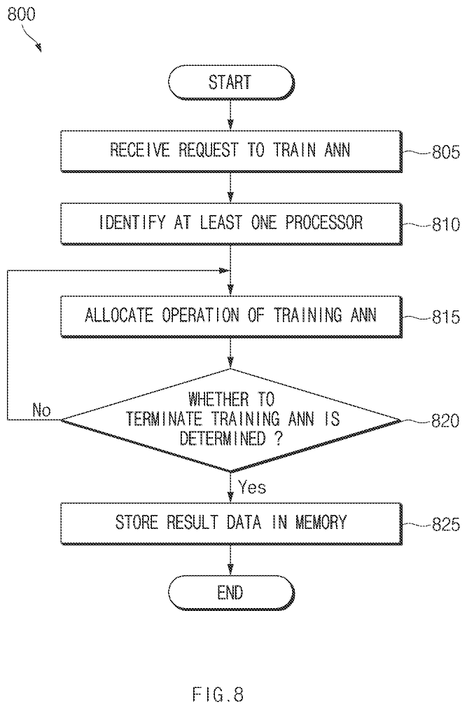

FIG. 8 illustrates a flowchart 800 for the operation of an electronic device, according to various embodiments.

According to an embodiment, an electronic device (e.g., the electronic device 101 of FIG. 1) may perform operations of FIG. 8. For example, a processor (e.g., the processor 120 of FIG. 1) of the electronic device may be configured to perform the operations of FIG. 8, when instructions stored in a memory (e.g., the memory 130 of FIG. 1) are executed.

In operation 805, the electronic device may receive a request to train a neural network. The description of the operation of receiving the request to train the neural network may be understood by making reference to the description of operation 705 of FIG. 7, and the details of operation 805 will be omitted below.

In operation 810, the electronic device may identify at least one processor. For example, the electronic device may classify and identify processors corresponding to a plurality of operations (e.g., a forward propagation operation and a backward propagation operation) necessary for training the ANN. For example, the electronic device may identify the first processor (e.g., the main processor 121 of FIG. 1) as a processor optimized for a forward propagation operation using an ANN. For another example, the electronic device may identify the second processor (e.g., the auxiliary processor 123 of FIG. 1) as a processor optimized for a backward propagation operation using an ANN.

In operation 815, the electronic device may allocate an ANN training operation. For example, the electronic device may allocate data allowing the first processor to perform the forward propagation operation through the ANN. For another example, the electronic device may allocate data allowing the second processor to perform the backward propagation operation using the ANN.

In operation 820, the electronic device may determine whether to terminate the ANN training operation.

For example, when the electronic device terminates the ANN training operation (e.g., “Yes” of operation 820), the electronic device may perform operation 825. For another example, when the electronic device does not terminate training the ANN (e.g., “No” of operation 820), the electronic device may perform operation 815.

In operation 825, the electronic device may store result data in the memory. For example, the electronic device may store, in the memory, data generated in the process of performing the ANN training operation.

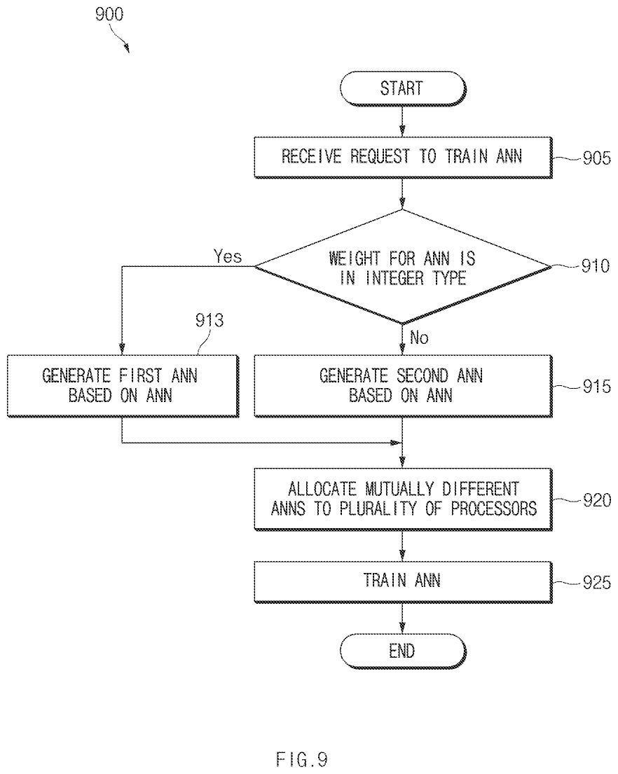

FIG. 9 illustrates a flowchart 900 for the operation of an electronic device, according to various embodiments.

According to an embodiment, an electronic device (e.g., the electronic device 101 of FIG. 1) may perform operations of FIG. 9. For example, a processor (e.g., the processor 120 of FIG. 1) of the electronic device may be configured to perform the operations of FIG. 9, when instructions stored in a memory (e.g., the memory 130 of FIG. 1) are executed.

In operation 905, the electronic device may receive a request to train a neural network. The description of the operation of receiving the request to train the neural network may be understood by making reference to the description of operation 705 of FIG. 7, and the details of operation 905 will be omitted below.

In operation 910, the electronic device may determine whether a weight included in the ANN to be trained corresponds to an integer value.

For example, when the weight included in the ANN to be trained corresponds to an integer value (e.g., “Yes” of operation 910), the electronic device may perform operation 913. For example, when the weight included in the ANN to be trained corresponds to a decimal value (e.g., “No” of operation 910), the electronic device may perform operation 915.

In operation 913, the electronic device may generate the first ANN based on the ANN to be trained. For example, the electronic device may quantize the ANN to be trained, through the first processor (e.g., the main processor 121 of FIG. 1) or the quantization module (e.g., the quantization module 425 of FIG. 4). The first ANN may be referred to as an ANN obtained by quantizing the ANN to be trained.

In operation 915, the electronic device may perform the second ANN based on the ANN to be trained. For example, the electronic device may de-quantize the ANN to be trained, through the first processor or the quantization module. The second ANN may be referred to as an ANN obtained by de-quantizing the ANN to be trained.

In operation 920, the electronic device may allocate mutually different ANNs to a plurality of processors. For example, the electronic device may load the first ANN to the first processor (e.g., the auxiliary processor 123 of FIG. 1). For another example, the electronic device may load the second ANN to the second processor (e.g., the main processor 121 of FIG. 1).

In operation 925, the electronic device may perform an ANN training operation. For example, the electronic device may perform the ANN training operation based on data allocated to the plurality of processors in operation 920.

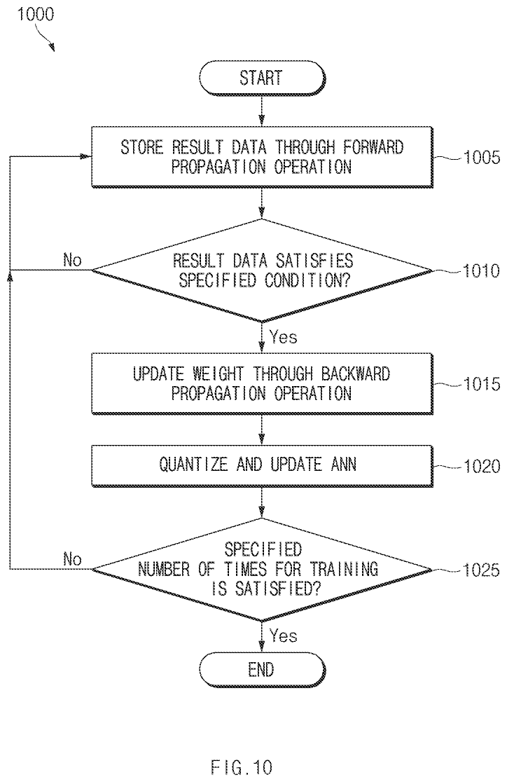

FIG. 10 illustrates a flowchart 1000 for the operation of an electronic device, according to various embodiments.

According to an embodiment, an electronic device (e.g., the electronic device 101 of FIG. 1) may perform operations of FIG. 10. For example, a processor (e.g., the processor 120 of FIG. 1) of the electronic device may be configured to perform the operations of FIG. 10, when instructions stored in a memory (e.g., the memory 130 of FIG. 1) are executed.

In operation 1005, the electronic device may store result data, which is obtained through the forward propagation operation, in the memory. For example, the electronic device may load the first ANN to the first processor (e.g., the auxiliary processor 123 of FIG. 1). The first processor may perform the forward propagation operation by inputting input data into the first ANN, and may store, in the memory, at least some of data generated from at least one layer in the first ANN in the process of performing the forward propagation operation.

In operation 1010, the electronic device may determine whether result data, which is output by performing the forward propagation operation with respect to the first ANN, satisfies a specified condition. For example, the electronic device may determine whether the result data satisfies a batch count of input data.

For example, when the result data satisfies the specified condition (e.g., “Yes” of operation 1010), the electronic device may perform operation 1015. For another example, when the result data fails to satisfy the specified condition (e.g., “No” of operation 1010), the electronic device may repeatedly perform operation 1005.

In operation 105, the electronic device may update the weight through the backward propagation operation. For example, the electronic device may load the second ANN to the second processor (e.g., the main processor 121 of FIG. 2). The second processor may perform the backward propagation operation with respect to the second ANN and may update weights included in at least one layer inside the second ANN, based on the backward propagation operation.

In operation 1020, the electronic device may quantize the second ANN having weights which are updated in operation 1015. For example, the electronic device may allow the first processor or the quantization module (e.g., the quantization module 425 of FIG. 4) to perform quantization with respect to the second ANN and to generate a third ANN, after updating weights included in the second ANN through the backward propagation operation. The electronic device may update the first ANN, which is loaded to the first processor, to the third ANN.

In operation 1025, the electronic device may determine whether the number of times of training the ANN satisfies a specified value.

For example, when the number of times of training the ANN satisfies a specified value (e.g., “Yes” of operation 1025), the electronic device may terminate training the ANN. For example, when the number of times of training the ANN fails to satisfy the specified value (e.g., “No” of operation 1025), the electronic device may perform operation 1005.

According to various embodiments of the disclosure, an electronic device may include a first processor, a second processor, and a memory which stores at least one artificial neural network (ANN) including an input layer and an output layer and is operatively connected with the first processor and the second processor.

According to an embodiment, the first processor may be configured to receive a request to train the ANN, perform a forward propagation operation by inputting input data into the input layer of a first ANN of the at least one ANN, and store, in the memory, first result data generated based on the forward propagation operation, and the second processor may be configured to perform a backward propagation operation by inputting the first result data into the output layer of a second ANN of the at least one ANN, and update weights included in the second ANN based on the backward propagation operation.

According to an embodiment, the first ANN and the second ANN may further include at least one layer, the first processor may store, in the memory, at least a portion of data generated from the at least one layer in a process of performing the forward propagation operation, and the second processor may store, in the memory, at least a portion of data generated from the at least one layer during performing the backward propagation operation.

According to an embodiment, the first ANN may correspond to an ANN which is generated, as the first processor quantizes an ANN determined based on the request to train the ANN, and the second ANN may correspond to an ANN which is generated as the first processor de-quantizes to the ANN determined based on the request to train the ANN.

According to an embodiment, the first processor may be configured to generate a third ANN by quantizing the second ANN having the weights updated based on the backward propagation operation, and store, in the memory, the third ANN.

According to an embodiment, at least one layer in the first ANN and the third ANN may include a weight having an integer value, and at least one layer in the second ANN may include a weight having a decimal value.

According to an embodiment, the electronic device may be configured to terminate an ANN training operation, when the ANN training operation is determined as satisfying a specified condition, and repeatedly perform the ANN training operation, when the ANN training operation is determined as failing to satisfy the specified condition.

According to an embodiment, the electronic device may further include a software development kit (SDK) or an application programming interface (API) stored in the memory, and the electronic device may be configured to receive an external input for changing a setting value of the SDK or the API, and perform the ANN training operation based on the changed setting value.

According to an embodiment of the disclosure, the input data used for the forward propagation operation by the first processor ma include activation data.

According to an embodiment, the electronic device may further include a learning distributor stored in the memory, and the learning distributor may be configured to distribute and transmit a control signal and data for training the ANN to the first processor or the second processor such that the first processor or the second processor performs a different neural network processing operation in response to the request to train the ANN.

According to an embodiment of the disclosure, the first processor may correspond to a neural processing unit (NPU), and the second processor may correspond to a central processing unit (CPU) or a graphic processing unit (GPU).

According to various embodiments of the disclosure, a method for performing an operation of training an artificial neural network (ANN) by an electronic device may include receiving a request to train the ANN, performing, through a first processor, a forward propagation operation by inputting input data into the input layer of a first ANN, and storing, in a memory, first result data generated based on the forward propagation operation, and performing, through a second processor, a backward propagation operation by inputting the first result data into the output layer of a second ANN, and updating weights included in the second ANN based on the backward propagation operation.

According to an embodiment, the first ANN and the second ANN may further include at least one layer, and the method for performing the operation of training the ANN may include storing, in the memory, at least a portion of data generated from the at least one layer in a process of performing the forward propagation operation, and storing, in the memory, at least a portion of data generated from the at least one layer in a process of performing the backward propagation operation.

According to an embodiment, the first ANN may correspond to an ANN which is generated as the first processor quantizes an ANN determined based on the request to train the ANN, and the second ANN may correspond to an ANN which is generated as the first processor de-quantizes the ANN determined based on the request to train the ANN.

According to an embodiment, the method for performing the operation of training the ANN may further include generating a third ANN by quantizing the second ANN having the weights updated based on the backward propagation operation, and storing, in the memory, the third ANN.

According to an embodiment, at least one layer in the first ANN and the third ANN may include a weight having an integer value, and at least one layer in the second ANN may include a weight having a decimal value.

According to an embodiment, the method for performing the operation of training the ANN may further include terminating an operation of training the ANN, when the operation of training the ANN is determined as satisfying a specified condition, and repeatedly performing the operation of training the ANN, when the operation of training the ANN is determined as failing to satisfy the specified condition.

According to an embodiment, the method for performing the operation of training the ANN may further include receiving an external input for changing a setting value of an SDK or an API stored in the memory, and performing the operation of training the ANN based on the changed setting value.

According to an embodiment, the method for performing the operation of training the ANN may further include distributing and transmitting, by a learning distributor, a control signal and data for training the ANN to the first processor or the second processor such that the first processor or the second processor performs a different neural network processing operations in response to the request to train the ANN.

1. An electronic device comprising:
a first processor;
a second processor; and
a memory configured to store at least one artificial neural network (ANN) including an input layer and an output layer and operatively connected with the first processor and the second processor,
wherein the first processor is configured to:
receive a request to train the ANN;
perform a forward propagation operation by inputting input data into an input layer of a first ANN of the at least one ANN; and
store, in the memory, first result data generated based on the forward propagation operation, and
wherein the second processor is configured to:
perform a backward propagation operation by inputting the first result data into an output layer of a second ANN of the at least one ANN; and
update weights included in the second ANN based on the backward propagation operation.

2. The electronic device of claim 1, wherein the first ANN and the second ANN further include at least one layer in addition to the input layer and the output layer,
wherein the first processor is further configured to:
store, in the memory, at least a portion of data generated from the at least one layer during performing the forward propagation operation, and
wherein the second processor is further configured to:
store, in the memory, at least a portion of data generated from the at least one layer during performing the backward propagation operation.

3. The electronic device of claim 1,
wherein the first ANN is generated as the first processor quantizes an ANN determined based on the request to train the ANN, and
wherein the second ANN is generated as the first processor de-quantizes the ANN determined based on the request to train the ANN.

4. The electronic device of claim 1, wherein the first processor is further configured to:
generate a third ANN by quantizing the second ANN having the weights updated based on the backward propagation operation; and
store, in the memory, the third ANN.

5. The electronic device of claim 4,
wherein at least one layer in the first ANN and the third ANN includes a weight having an integer value, and
wherein at least one layer in the second ANN includes a weight having a decimal value.

6. The electronic device of claim 1,
wherein the electronic device is configured to:
terminate an operation of training the ANN, when the operation of training the ANN is determined as satisfying a specified condition, and
wherein the electronic device is configured to:
repeatedly perform the operation of training the ANN, when the operation of training the ANN is determined as failing to satisfy the specified condition.

7. The electronic device of claim 1, further comprising:
at least one of a software development kit (SDK) or an application programming interface (API) stored in the memory, and
wherein the electronic device is configured to:
receive an external input for changing a setting value of the SDK or the API; and
perform an operation of training the ANN based on the changed setting value.

8. The electronic device of claim 1, wherein the input data used for the forward propagation operation by the first processor includes activation data.

9. The electronic device of claim 1, further comprising:
a learning distributor stored in the memory,
wherein the learning distributor is configured to:
distribute and transmit a control signal and data for training the ANN to the first processor or the second processor such that the first processor or the second processor performs a different neural network processing operation in response to the request to train the ANN.

10. The electronic device of claim 1,
wherein the first processor corresponds to a neural processing unit (NPU), and
wherein the second processor corresponds to at least one of a central processing unit (CPU) or a graphic processing unit (GPU).

11. A method for performing an operation of training an artificial neural network (ANN) by an electronic device, the method comprising:
receiving a request to train the ANN;
performing, through a first processor, a forward propagation operation by inputting input data into an input layer of a first ANN, and storing, in a memory, first result data generated based on the forward propagation operation; and
performing a backward propagation operation by inputting the first result data into an output layer of a second ANN, and updating weights included in the second ANN based on the backward propagation operation.

12. The method of claim 11,
wherein the first ANN and the second ANN further include at least one layer, and
wherein the method for performing the operation of training the ANN further comprises:
storing, in the memory, at least a portion of data generated from the at least one layer in a process of performing the forward propagation operation, and
storing, in the memory, at least a portion of data generated from the at least one layer in a process of performing the backward propagation operation.

13. The method of claim 11,
wherein the first ANN is generated as the first processor quantizes an ANN determined based on the request to train the ANN, and
wherein the second ANN is generated as the first processor de-quantizes the ANN determined based on the request to train the ANN.

14. The method of claim 11, wherein the method for performing the operation of training the ANN further includes:
generating a third ANN by quantizing the second ANN having the weights updated based on the backward propagation operation; and
storing the third ANN in the memory.

15. The method of claim 11, wherein the method for performing the operation of training the ANN further includes:
terminating the operation of training the ANN, when the operation of training the ANN is determined as satisfying a specified condition, and
repeatedly performing the operation of training the ANN, when the operation of training the ANN is determined as failing to satisfy the specified condition.
